(19) United States
(12) Patent Application Publication
(10) Pub. No.: US 2019/0188790 A1
(43) Pub. Date: Jun. 20, 2019

(54) APPARATUS, SYSTEM, AND METHOD FOR INTELLIGENT CHOICE IN CURRENCY

(71) Applicant: Safehaven Labs, Inc., West Jordan, UT (US)

(72) Inventors: Christopher J. Lovato, West Jordan, UT (US); Lawrence D. Hilton, Alpine, UT (US); Michael Alan Shattuck, South Jordan, UT (US)

(21) Appl. No.: 16/225,841

(22) Filed: Dec. 19, 2018

Related U.S. Application Data
(60) Provisional application No. 62/607,553, filed on Dec. 19, 2017.

(51) Int. Cl. G06Q 40/04; G06Q 20/10; G06Q 30/02; G06Q 20/38

(52) U.S. Cl. CPC G06Q 40/04; G06Q 20/381; G06Q 30/0283; G06Q 20/10

(57) ABSTRACT

An apparatus for calculating and executing currency exchanges including a currency gain module that compares a predominant base currency against one or more complementary currencies to calculate their respective percentage gains in the base currency over time, a currency pullback module that calculates a pullback score for each complementary currency over time, and a currency path module that determines one or more currency paths comprising one or more successive trades in which a complementary currency exceeding a gain threshold and satisfying a pullback threshold is traded. The currency gain module, the currency pullback module, and the currency path module comprise one or more of logic hardware and executable code, the executable code stored on one or more non-transitory computer-readable media.

### CROSS-REFERENCE TO RELATED APPLICATIONS

This application, under 35 U.S.C. § 119, claims the benefit of U.S. Provisional Patent Application Ser. No. 62/607,553 filed on Dec. 19, 2017, and entitled “Apparatus, System, And Method For Intelligent Choice In Currency,” the contents of which are hereby incorporated by reference herein.

### COPYRIGHT NOTICE

A portion of the disclosure of this patent application document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TRADEMARKS DISCLAIMER

The product names used in this document are for identification purposes only. All trademarks and registered trademarks are the property of their respective owners.

### FIELD OF THE DISCLOSURE

The disclosed apparatus and methods determine trades among a base currency and one or more complementary currencies so as to maximize a user's return on savings and purchasing power.

### BACKGROUND

For investors, savers, or others wishing to optimize their return on an investment, it is often difficult, or inconvenient to time trades, sales, purchase, and the like in order to deliver the best return. This difficulty can be compounded when multiple currencies, commodities, and the like are involved in the transaction. Accordingly, there is a need for systems and methods that compensate for the above-noted and other difficulties and inconveniences.

### SUMMARY

Reference throughout this specification to features, advantages, or similar language does not imply that all of the features and advantages that may be realized with the presently disclosed embodiments should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics of the disclosed embodiments may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments.

These features and advantages of the presently disclosed embodiments will become more fully apparent from the following description and appended claims, or may be learned by the practice of the invention as set forth hereinafter.

In order that the advantages of the invention will be readily understood, a description of the invention will be rendered by reference to specific embodiments that are illustrated in the appended drawings. These drawings depict only typical embodiments of the invention and are not therefore to be considered to be limiting of its scope.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Many of the functional units described in this specification have been labeled as modules, in order to more particularly emphasize their implementation independence. A module may comprise utilitarian objects of any kind, including mechanical structures or devices, electrical devices, electromechanical devices, optical devices, analog electronics, digital electronics, and so forth. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Accordingly, disclosed embodiments include an apparatus having a currency gain module that compares a predominant base currency against one or more complementary currencies to calculate their respective percentage gains in the base currency over time, a currency pullback module that calculates a pullback score for each complementary currency over time, and a currency path module that determines one or more currency paths comprising one or more successive trades in which a complementary currency exceeding a gain threshold and satisfying a pullback threshold is traded. Embodiments of the currency gain module, the currency pullback module, and the currency path module include one or more of logic hardware and executable code, the executable code stored on one or more non-transitory computer-readable media.

In further disclosed embodiments, the apparatus includes a currency sort module that monotonically orders the complementary currencies by their respective percentage gains. In still further disclosed embodiments, the apparatus includes a currency hop module that calculates percentage gains between complementary currencies and identifies any currency paths that would achieve a higher overall percentage gain relative to the base currency than by trading each complementary currency alone.

In still further disclosed embodiments, the apparatus includes a currency select module that determines respective amounts of base currency yielded by trading predetermined amounts of the complementary currencies in descending order of percentage gain so as to achieve a total predetermined amount of base currency. In still further embodiments, the trading determined by the currency select module comprises at least one currency path. In still further embodiments, the at least one currency path comprises at least two successive trades. In still further embodiments, the apparatus includes a paper legal tender trust account module, an exchange rate module, an arbitrage hedge account module, a bullion exchange module, a specie legal tender holdings module, and a specie legal tender disbursement module. In still further embodiments, the apparatus includes a specie legal tender transaction entry module, a specie legal tender transaction verification module, a tax accounting module, a form of tender determination module, and a specie legal tender transaction execution module. In still further embodiments, the apparatus includes a transactor verification module, an account verification module, an available balance verification module, and an account reconciliation module. In still further embodiments, one or more of the modules use of one or more of a debit card, credit card, internet, telecommunications, wire transfer, and Automated Clearing House (“ACH”) system, by which information needed to execute a transaction is communicated to the apparatus and status of the transaction is communicated to transacting parties.

Also disclosed is a computer program product comprising a non-transitory computer readable medium having computer usable program code executable to perform operations for intelligent choice in currency, the operations of the computer program product including comparing a predominant base currency against one or more complementary currencies to calculate their respective percentage gains in the base currency over time, calculating a pullback score for each complementary currency over time, and determining one or more currency paths comprising one or more successive trades in which a complementary currency exceeding a gain threshold and satisfying a pullback threshold is traded, monotonically ordering the complementary currencies by their respective percentage gains, calculating percentage gains between complementary currencies and identifying any currency paths that would achieve a higher overall percentage gain relative to the base currency than by trading each complementary currency alone, determining respective amounts of base currency yielded by trading predetermined amounts of the complementary currencies in descending order of percentage gain so as to achieve a total predetermined amount of base currency.

### BRIEF DESCRIPTION OF THE DRAWINGS

FIG. 1 is a schematic block diagram illustrating a system of an embodiment, including a computer and an intelligent choice in currency (“ICC”) subsystem.

FIG. 2 is a schematic block diagram illustrating an intelligent choice in currency apparatus, including a currency gain module, a currency pullback module, a currency path module, a currency sort module, a currency hop module, and a currency select module in accordance with disclosed embodiments.

FIG. 3 illustrates a possible computer hardware platform upon which disclosed embodiments may be at least in part deployed.

FIG. 4 is a diagram of a possible computer including a software stack in which the disclosed embodiments may at least in part reside.

FIG. 5A is a schematic overview of a system in accordance with disclosed embodiments.

FIG. 5B is a schematic overview of a system in accordance with disclosed embodiments.

FIG. 6 is a schematic flow diagram illustrating a spending operation of the system 100 in accordance with disclosed embodiments.

FIG. 7 is a schematic flow diagram illustrating a saving operation of the system 100 in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

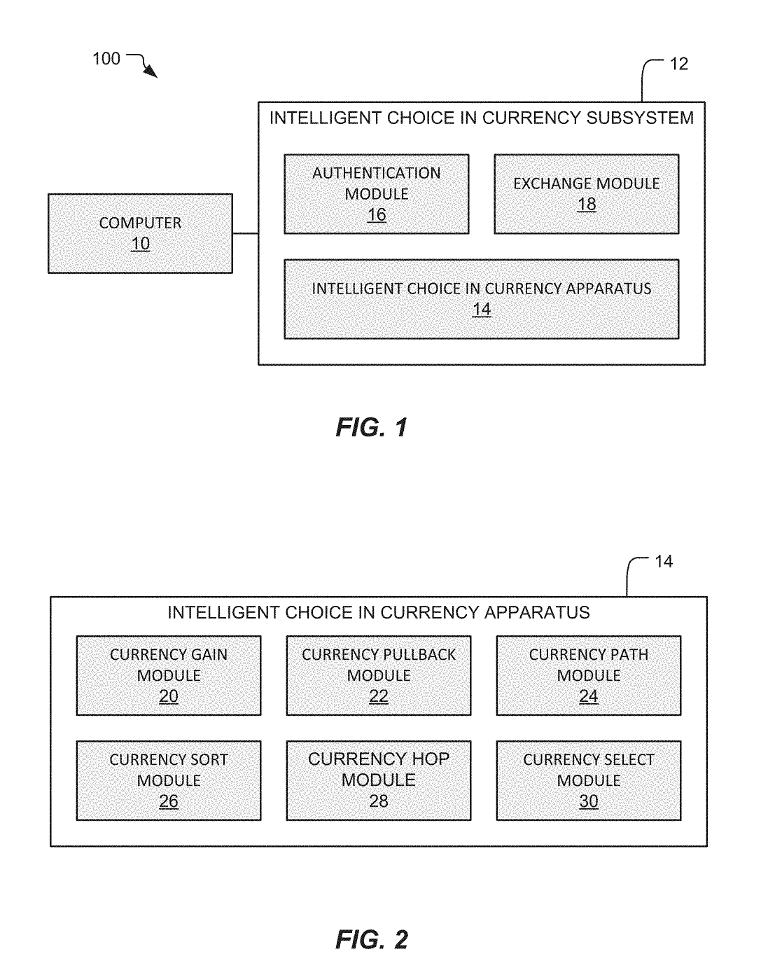

FIG. 1 is a schematic block diagram illustrating a system 100 of a present embodiment, including a computer 10 and an intelligent choice in currency (“ICC”) subsystem 12. The subsystem 12 further includes an ICC apparatus 14, an authentication module 16, and an exchange module 18. In an embodiment, the foregoing components of the subsystem 12 may be fully or partially implemented within a hardware platform and/or a software stack of the computer 10.

The ICC apparatus 14 may determine trades among a base currency and one or more complementary currencies so as to maximize a user's return on savings and purchasing power.

The authentication module 16 may validate the user's identity and account holdings of base currency and complementary currency.

The exchange module 18 may execute trades as determined by the apparatus 14, in conjunction with maximizing account holdings and optimally fulfilling spending transactions.

FIG. 2 is a schematic block diagram illustrating an ICC apparatus 14, including a currency gain module 20, a currency pullback module 22, a currency path module 24, a currency sort module 26, a currency hop module 28, and a currency select module 30. The currency gain module 20 compares a predominant base currency against one or more complementary currencies to calculate their respective percentage gains in the base currency over time. The currency pullback module 22 calculates a pullback score for each complementary currency over time. The currency path module 24 determines one or more currency paths comprising one or more successive trades in which a complementary currency exceeding a gain threshold and satisfying a pullback threshold is traded. The currency sort module 26 monotonically orders the complementary currencies by their respective percentage gains. The currency hop module 28 calculates percentage gains between complementary currencies and identifies any currency paths that would achieve a higher overall percentage gain relative to the base currency than by trading each complementary currency alone. The currency select module 30 determines respective amounts of base currency yielded by trading predetermined amounts of the complementary currencies in descending order of percentage gain so as to achieve a total predetermined amount of base currency.

In one embodiment, the trading determined by the currency select module 30 may comprise at least one currency path. In a further embodiment, the currency path may comprise at least two successive trades.

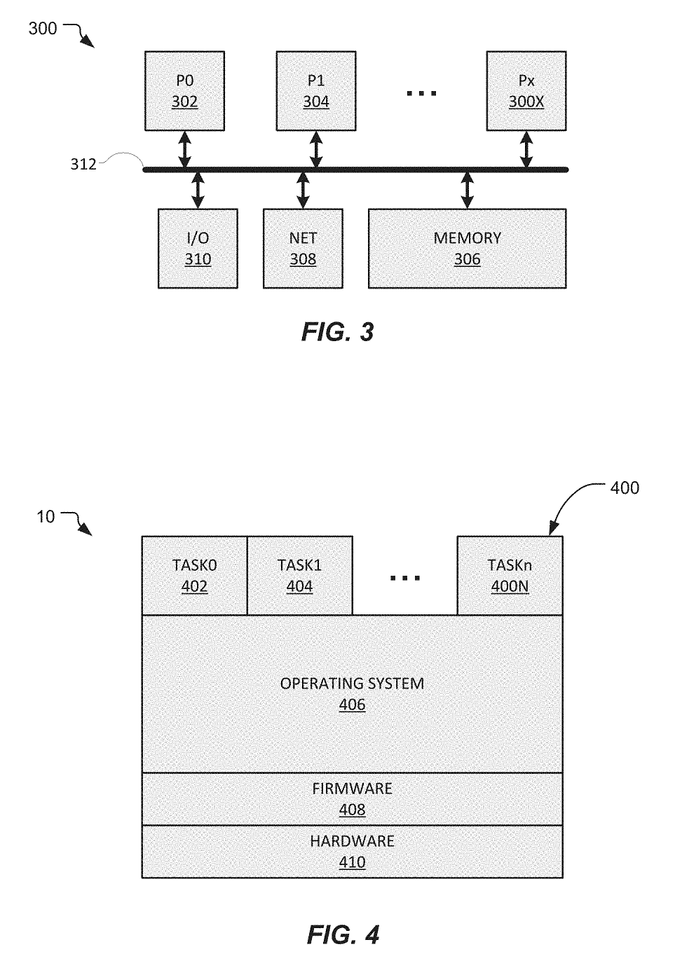

FIG. 3 illustrates a possible computer hardware platform 300 upon which the disclosed system 100 may be at least in part deployed. The hardware platform 300 may include processor(s) 302, 304, 300X, memory 306, a network interface 308, and an I/O (Input/Output) device interface 310, connected through a bus 312.

The hardware platform 300 may be of any form factor or type, including an embedded system, a handheld, a notebook, a personal computer, a minicomputer, a server, a mainframe, a supercomputer, and the like.

The processor(s) 302, 304, 300X may be present in any quantity, including a uniprocessor, and may have any instruction set architecture. In an embodiment, the processor(s) 302, 304, 300X may have one or more levels of dedicated or shared caches. Possible physical implementations may include multi-chip, single chip, multi-core, hyperthreaded processors, and the like.

The memory 306 may be of any size or organization and may include both read/write and read-only sections. It may also include both global and local sections, and may support both uniform and non-uniform access. It may incorporate memory-mapped I/O and direct memory access. It may support cache coherency, including directory-based and snoop-based protocols.

The network interface 308 may support any network protocol or architecture. It may support both wireless and hard-wired network connections. It may comprise Ethernet, Token Ring, System Network Architecture (“SNA”), and the like. In one embodiment, it may be integrated with the I/O device interface 310.

The I/O device interface 310 may be driven primarily by the processor(s) 302, 304, 300X or may incorporate an independent I/O processor subsystem. It may comprise Peripheral Component Interconnect (“PCI”), Small Computer System Interface (“SCSI”), Fiberchannel (“FC”), Enterprise System Connection (“ESCON”), ESCON over Fiberchannel (“FICON”), and the like. In an embodiment, it may include dedicated local I/O devices.

The bus 312 may comprise one or more of a variety of physical and logical topologies. It may be parallel or serial. It may be unidirectional or bidirectional. It may be flat or hierarchical. It may comprise a full or partial crossbar. It may comprise multiple bridged busses. In an embodiment, the bus may comprise a high-speed internal network.

FIG. 4 is a diagram of a possible computer 10 including a software stack 400 in which the present invention may at least in part reside. The software stack 400 may include task(s) 402, 404, 400N, hosted on an operating system 406, enabled by firmware 408, running on a hardware platform 410 of which the configuration of FIG. 3 is representative.

The task(s) 402, 404, 400N may include both user- and system-level tasks. They may be interactive or batch. They may run in the foreground or background. User-level task(s) may include applications, programs, jobs, middleware, and the like. System-level task(s) may include services, drivers, daemons, utilities, and the like.

The operating system 406 may be of any type and version and in any state. Types may include Unix, Linux, Windows, Mac, MVS, VMS, and the like. Versions may include Windows XP, Windows Vista, and the like. States may include a degree of customization, a mode of operation, a system preparation for setup, and the like. The operating system 406 may be single-user or multi-user. It may be single-tasking or multi-tasking. In an embodiment, the operating system 406 may be real-time. In another embodiment, the operating system 406 may be embedded.

The firmware 408 may comprise microcode, which may reside in a microstore of the processor(s) 402, 404, 400N. In an embodiment, the firmware 408 may comprise low-level software, which may reside in memory (e.g., memory 306). In one embodiment, the firmware 408 may comprise a rudimentary operating system. In a further embodiment, the firmware 408 may support virtualization so as to permit the concurrent operation of multiple operating systems on a hardware platform 412.

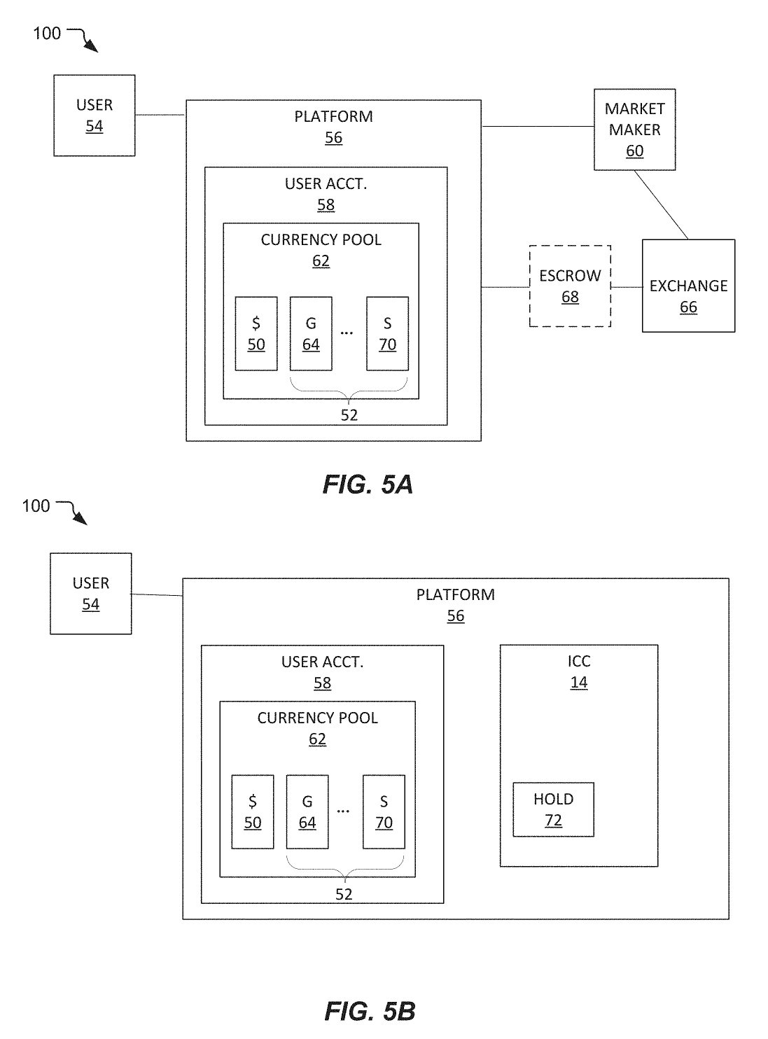

FIG. 5A is a schematic overview of a system 100 in accordance with disclosed embodiments. A base currency 50 may comprise a fiat currency such as US dollars (“USD”), Euros, and the like. Complementary currencies 52 may comprise gold dollars, silver dollars, platinum dollars, quints, squints, British pounds, cryptocurrencies such as Bitcoin and Ethereum, Euros, and so forth. A user 54 may join the platform 56 and deposit base currency 50 into their account 58. The money may be accepted by a fiat market maker 60 (such as Silicon Valley Bank, or the like). The money may be added to the user's currency pool 62.

A user 54 may join the platform 56 and immediately exchange for complementary currencies 52, such as gold 64, using ACH, a debit/credit card, or the like. The money may be accepted by a fiat market maker 60. The money may be (temporarily) added to the user's 54 currency pool 62. A trade may be automatically initiated with a monetary exchange 66 (such as NAMX) for the amount of gold 64 that can be exchanged for the deposited base currency 50 value. An escrow account 68 may be created and, upon execution and settlement of the trade, ownership of the gold 64 and deposited base currency 50 swapped. The user may be notified of the trade completion.

FIG. 5B is a schematic overview of a system 100 in accordance with disclosed embodiments and illustrates the following example. A user 54 may make a purchase in base currency 50 (such as US Dollars) with his/her account 58 and have a currency pool 62 of three different currencies as follows: a base currency 50 ($1000 USD) and two complementary currencies 52 comprising Gold Coins 64 valued at $3000 USD which is up by 5%, where “up” refers to the market value in comparison to the USD, and Silver Coins 70 valued at $10,000 USD which is down by 15%, where “down” refers to the market value in comparison to the USD. The system 100 may ensure that the user 54 has an account 58 balance sufficient to cover the costs of any transaction. A market analysis may be done by ICC apparatus 14. Based on the market analysis, ease of/speed of/ability to easily trade, the user's account 58 history and the user's ICC apparatus 14 settings a set of currencies may be chosen to trade for dollars in order to complete the purchase. Assuming the currency pool 62 above and default ICC apparatus 14 settings, gold 64 would be selected to trade into dollars. A balance hold 72 for the amount in USD may be placed on the selected currency. This balance hold 72 fluctuates in the currency based on the market until the time of a trade to ensure that the specific dollar amount is available until a trade can be completed. The amount in dollars may be released by a card provider (such as the platform 56 provider, Safehaven) for the transaction. The system 100 may look for an acceptable trade at a value slightly lower than (gold to USD) the market value. Anything above the required USD amount may be sent to the card provider as a transaction fee. The user 54 may be able to see the updated balance in any version of the platform 56 such as mobile and web apps. The user 54 may get a notification (or a spending summary per week) that details what was saved by ICC apparatus 14.

System 100 uses data to make recommendations based on spending patterns and may automate currency pool 52 spread. For those looking mostly to invest and grow their account 58 balance, the focus is more on growth strategies. For those with a high amount of spend transactions, the focus is more on currency stability and flow enhancement. In some embodiments, the currency pool 62 may including things other than just currency such as stocks, bonds, and the like. For example, users 54 may buy a candy bar with a publicly traded stock, or a car with some stock, some gold, and USD. The user 54 may own a portion of a share in stock similar to the way ownership of fractions or cents in gold is allowed. This fractional ownership allow micro-transactions of portions of shares as well as coins/currency. The system 100 is adaptable to any asset that supports the flow.

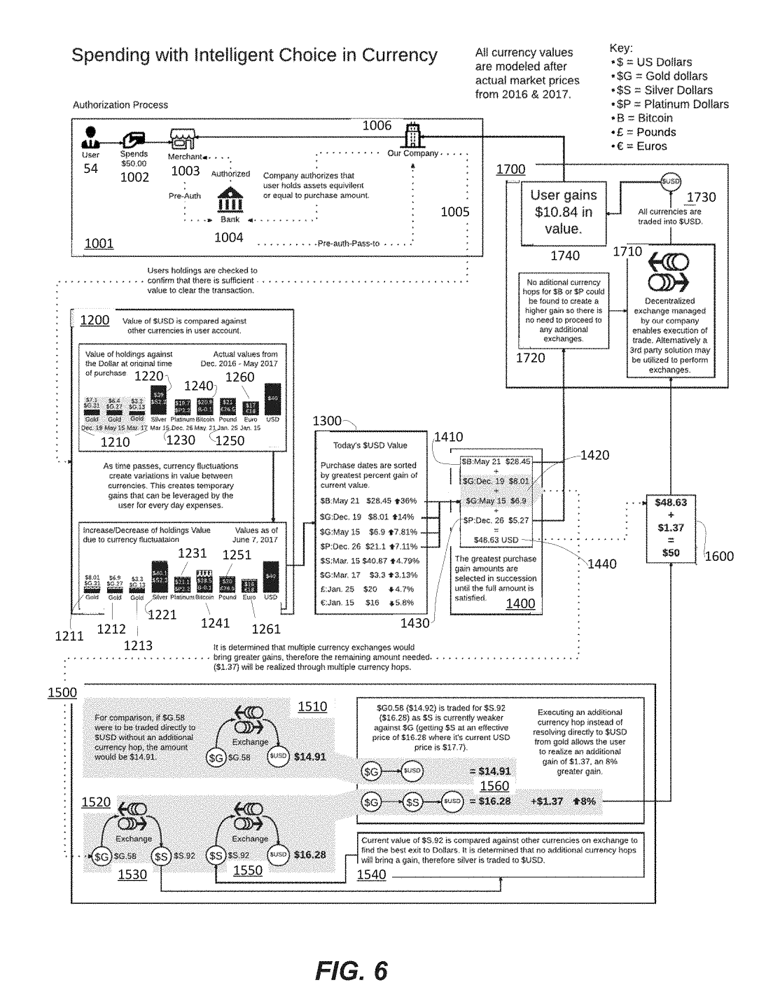

FIG. 6 is a schematic flow diagram illustrating a spending operation of the system 100 in accordance with disclosed embodiments. As shown in box 1001, a preauthorization process that may occur when a user 54 purchases something by swiping a credit/debit card. A user's 54 identity may have been verified and cleared through the proper know-your-customer (“KYC”) procedures. A debit/credit card may have been tied to user's 54 account, issued through partnering bank 1004 on behalf of a card provider for use by this user 54. As indicated at 1002 the card may be swiped to purchase something for $50.00 USD. At 1003, a merchant may accept debit or credit cards as payment for the $50.00 owed and swipe the card on their POS (Point Of Sale) card swiper/reader. Partnering bank 1004 may digitally pass the pre-authorization request they may receive from the merchant 1003 to a third party company 1006, such as platform 56 provider, to validate if the user 54 has sufficient funds (e.g., in currency pool 62). The funds that are recognized as holding value sufficient to cover the transaction may or may not be fully available in USD. The total amount needed may be held in more than one currency (e.g., in base currency 50 and complementary currencies 52).

The third party company 1006 may receive the pre-authorization request and convert any of the assets held in the user's 54 account 58 to USD and check, at 1005, that in this example user's 54 account 58 contains in currency pool 62 a combined total value of $183.91 USD, more than enough to cover the total transaction request of $50.00 USD. A request may be forwarded back through the partnering bank 1004 to the merchant's 1003 POS terminal authorizing the transaction. Because it may take several days (up to 30 days, for example) to fully settle a transaction the company 1006 may have a small window of time in which it is able to liquidate the amount of funds needed by the partnering bank 1004 to send back to the merchant's 1003 bank. Within this window of time, ICC apparatus 14 may analyze the funds to determine a stronger possible exit for this user 54.

As indicated at 1200, a first step in the process that ICC apparatus 14 may follow to determine a better exit that this user 54 can obtain for this $50.00 purchase. As indicated at 1210, three Gold Dollar exchanges (e.g., exchanges 66) at different times at varying exchange amounts are represented. One exchange of $G0.31 for $7.1 on 12/19/2016, a second exchange of $G0.13 for $3.30 on 03/17/2017 and a third exchange of $G0.27 for $6.4 on 05/15/2017. The total value of the exchanges is $G0.71. Meta-data of exchange dates and the prices paid may have been stored automatically at the time of exchange and may now be analyzed for this transaction as follows. As indicated at 1211, Gold Dollar exchange of 12/19/2017 for $8.01 has realized gain of $0.91 (14%) with a total liquidation value of $8.01 as of the exchange date (06/07/2017). As indicated at 1212, Gold Dollar exchange of 05/15/2017 for $6.90 has realized gain of $0.50 (7.81%) with a total liquidation value of $6.09 as of the exchange date (06/07/2017). As indicated at 1213, Gold Dollar exchange of 04/17/2017 for $3.20 has realized gain of $0.10 (3.13%) with a total liquidation value of $3.30 as of the exchange date (06/07/2017).

As also indicated at 1220, the value of a single Silver Dollar exchange of $S2.3 for the price of $39.00 on 03/15/2016 is represented. Meta-data of exchange date and the price paid may have been stored automatically at the time of exchange and may now be analyzed for this transaction as follows. At 1221, Silver Dollar exchange of 04/15/2017 for $39.00 has realized gain of $1.1 (4.79%) with a total liquidation value of $40.87 as of the exchange date (06/07/2017). Another way of looking at this is the user 54 would need to liquidate 4.79% less total value for this $50.00 purchase if sufficient current holdings of Silver Dollars were liquidated to cover the purchase.

As also indicated at 1230, the value of a single Platinum Dollar exchange of $P2.2 for the price of $19.7 on 12/26/2016 is represented. Meta-data of exchange date and the price paid may have been stored automatically at the time of exchange and may now be analyzed for this transaction as follows. At 1231, Platinum Dollar exchange of 12/26/2017 for $19.7 has realized gain of $1.40 (7.11%) with a total liquidation value of $21.1 as of the exchange date (06/07/2017). Another way of looking at this is the user 54 would need to liquidate 7.11% less total value for this $50.00 purchase if sufficient current holdings of Platinum Dollars were liquidated to cover the purchase.

As also indicated at 1240, the value of a single Bitcoin exchange of $B0.1 for the price of $20.9 on 05/21/2017. Meta-data of exchange date and the price paid may have been stored automatically at the time of exchange and may now be analyzed for this transaction as follows. At 1241, a Bitcoin exchange of 5/21/2017 for $20.90 has realized gain of 7.55 (36%) with a total liquidation value of $28.50 as of the exchange date (06/07/2017). Another way of looking at this is the user 54 would need to liquidate 36% less total value for this $50.00 purchase if sufficient current holdings of BTC were liquidated to cover the purchase.

As indicated at 1250, the value of a single GBP exchange of £26.5 for the price of $21.00, on 01/25/2017. Meta-data of exchange date and the price paid may have been stored automatically at the time of exchange and may now be analyzed for this transaction as follows. At 1251, the GBP exchange has realized a loss of $1.00 (4.7%) with a total liquidation value of $20.00 as of the exchange date (06/07/2017). Another way of looking at this is the user 54 would need to liquidate 4.7% more total value for this $50.00 purchase if sufficient current holdings of GBP were liquidated to cover the purchase.

As shown at 1260, the value of a single EUR exchange of €18 for the price of $17.00, on 01/15/2017 is represented. Meta-data of exchange date and the price paid may have been stored automatically at the time of exchange and may now be analyzed for this transaction as follows. At 1261, the EUR exchange has realized a loss of $1.00 (5.8%) with a total liquidation value of $16.00 as of the exchange date (06/07/2017). Another way of looking at this is the user 54 would need to liquidate 5.8% more total value for this $50.00 purchase if sufficient current holdings of EUR were liquidated to cover the purchase.

As indicated at 1300, a step of the ICC apparatus 14 evaluation process is where all exchanges 66 (e.g., in exchange module 18) are evaluated. The exchanges 66 may first be sorted based on their relative gains to their exchange amount. Exchanges 66 that have realized the highest percentage gain may then be passed on to be evaluated for a multi-currency hop (e.g., in currency hop module 28) until the full transaction amount of $50.00 is satisfied.

As indicated at 1400, in this example only the currencies with the strongest gain against the USD were selected. It is possible that a currency with a weaker gain against the US Dollar may be selected if multiple currency exchanges could bring a greater gain. This is described below in connection with step 1500.

As indicated at 1410, Bitcoin exchange from 05/21/2017 valued at $28.45 is evaluated to determine if trading through one or several currencies could produce a greater gain. It is determined no additional gain can be obtained by trading Bitcoin for another currency, therefore this exchange may be immediately liquidated to USD. As indicated at 1420, Gold exchanges from 12/19/2016 and 05/15/2017 valued at $8.01 and $6.9 are then evaluated to find if trading through one or several currencies could produce a greater gain. It is determined that a greater gain can be obtained by trading gold for another currency before liquidating to USD. As indicated at 1430, Platinum exchange of 12/26/2016 valued at $21.10 is evaluated to determine if trading through one or several currencies could produce a greater gain. It is determined no additional gain can be obtained by trading platinum for another currency, therefore this exchange may be immediately liquidated to USD. As indicated at 1440, the amount realized after these exchanges are selected is $48.63, which is $1.37 short of the $50 needed. The $1.37 outstanding may be gained in the next step 1500 due to a multiple currency exchange.

As indicated at 1500, the value that would be realized if the gold exchanges were to be liquidated directly to USD instead of trading gold with other currencies before trading into USD is analyzed (e.g., in currency gain module 20). As indicated at 1520, executing multiple trades and moving between currencies in the proper order can produce greater gains than simply executing directly to USD. This is possible because all currencies experience value fluctuations against each other, irrespective of their individual value against the USD. Opportunities for gain are created because of those inter-currency value fluctuations. Every possible combination of currencies in every possible order may be considered including an unlimited number of inter-currency exchanges. For example, if the currency trade starts with gold it may generate the greatest gains hopping through 1, 2, 3 or more other currencies before finally liquidating to USD (e.g. Gold to Canadian Dollars to Euros to Ethereum to Platinum to US Dollars).

As indicated at 1530, gold may be compared with other currencies to determine which other currencies can create an eventual gain if first traded against gold before trading to USD. It may be determined that the ratio of gold to silver and then silver to gold is the strongest exit and will bring the greatest gain. Therefore, gold may be exchanged with silver. This exposes the reality that all currencies have value fluctuations against each other irrespective of their value against the USD.

As indicated at 1540, not only did silver offer a strong gain against gold in this example, it also represented a strong gain against the USD. The decision to select silver may be determined by the overall ratio experienced by both trading gold to silver and silver to USD. Silver may also be compared against other currencies to determine if additional currency hops (e.g., in currency hop module 28) would produce more gain. In this example it was determined that no additional gains were possible and thus trading from silver directly to USD would create the greatest gains. It is possible that even if silver had the greatest gains against gold that another currency or series of currency hops may have created greater gains. The strongest gain in a series of currency hops may be realized in the 1st, 2nd, 3rd, 4th or more hops. Analyzing any number of potential combinations may enable complex trades as described in this example.

As indicated at 1550, silver may be traded to USD in a final step in a series of exchanges. As indicated at 1560, the final gain after executing multiple exchanges (from gold to silver to USD) may be compared with the gain that would have been realized if gold had been traded directly to USD. Executing multiple exchanges created a $1.37 greater gain which is 8% more than would have been realized by liquidating gold directly to USD.

As shown at 1600, the final tally, taking the $48.63 that was realized if exchanging directly to USD and adding to that the $1.37 that was realized by a multiple currency exchange produces the needed amount of $50.

As shown at 1700, two scenarios are considered. In the 1st scenario shown in 1710, the company 1006 may own and manage the exchange 66 directly. In this scenario multiple currency exchanges may be more convenient as near-instantaneous exchanges can be executed. This exchange 66 may be decentralized or centralized.

In the 2nd scenario shown in 1720, the company 1006 may leverage a 3rd party exchange 66 which may make more currencies or capabilities available. In either scenario the exchange 66 may execute all trades and settle back to the USD if the user 54 is located in the United States, or any other country's fiat currency relative to the geographic location of the user 54 at the time of spend.

As also indicates at 1720, it may be recognized that for Bitcoin and platinum there is nothing more to be gained by additional currency exchanges so they may immediately be exchanged to USD. At 1730, all currencies may be traded to USD in order to fully execute the transaction which was originally instigated in USD. As shown at 1740, in the end the user gains (or saves) $10.84 in value on the $50 purchase which is essentially a 22% discount.

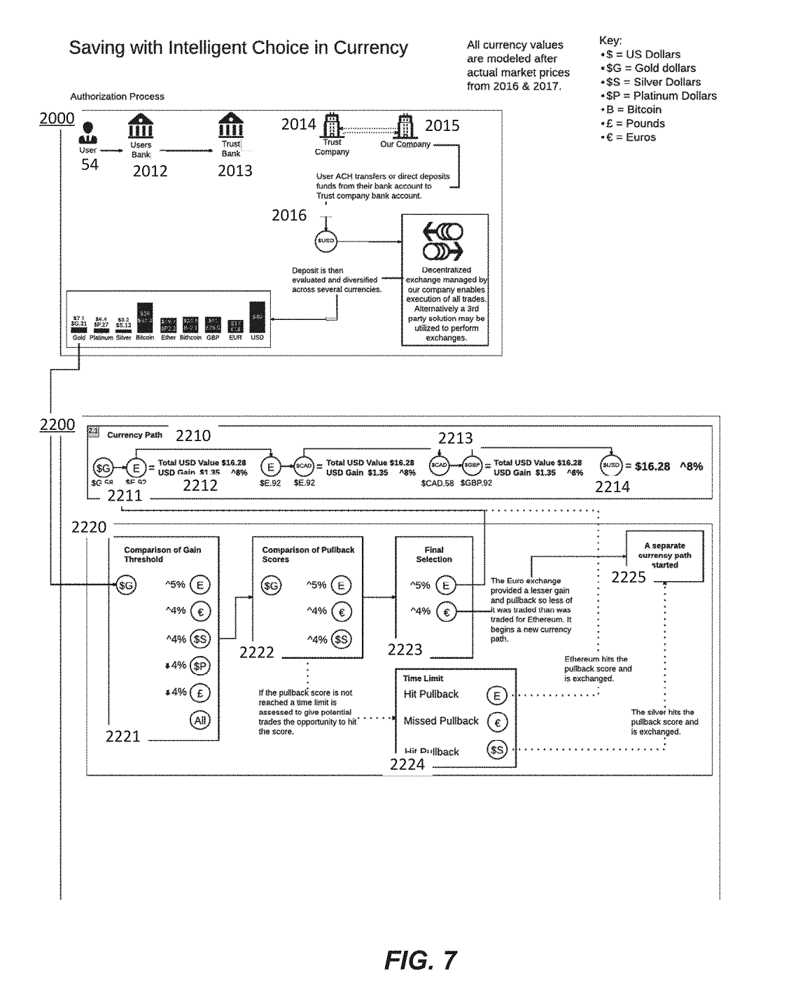

FIG. 7 is a schematic flow diagram illustrating a saving operation of the system 100 in accordance with disclosed embodiments. As shown in 2000, a process by which a user 54 transmits money held by a third party trust company 2014. As shown, a user 54 that has signed up for service with platform 56 may authorize ACH transmission from their bank account 2012 to a trust bank account 2013. As shown, ACH transfer of funds from user's bank account 2012 may be performed to a third party trust company 2014 partner connected into the platform 56. The partnering trust company 2014 may hold custody of the user's 54 funds.

The platform 54 provider company 2015 may receive digital communication that the trust company 2014 has received funds on behalf of the user 54 in the form of ACH transfer. The platform 54 provider company 2015 may use that communication to credit the transferred amount to the user's 54 available USD balance in the system 100. Since the user 54 has previously elected to use this transfer for ICC apparatus 14 to save the balance amount it may be passed on to be diversified as discussed below.

As indicated at 2016, the user's 54 account 58 balance may be evaluated by taking the total and splitting it into a number (e.g., 4-6) different sections equal in value. For example, $1,000 USD might split into 4 sections of $250 USD. The amount and number of splits may be determined by identifying better performing complementary currencies 52 against the user's 54 base currency 50. Each complementary currency 52 may be evaluated against base currency 50. The current and previous rates for each complementary currency 52 going back a predetermined amount of time may be compiled and compared. The gain percentage between the oldest rate and the current rate may be determined using the following formula: 1−(currentRate/originalRate). Trend may also be determined by calculating the linear slope of the rates for each complementary currency 52. Currencies 52 with the highest gains that are also trending up may be selected. If six complementary currencies 52 are trending up against the base currency 50 they may be selected. If only four are trending up, they may be selected. If less than four are trending up they may be selected and the remaining may be picked at random. If no complementary currencies 52 are trending up four currencies that are trending flat may be selected at random.

As shown in 2200, the system 100 uses a process of moving between currencies over time to realize a gain against the base currency 50 (in this example USD). In this example all three currency paths go through 3 inter-currency exchanges before moving back to the base currency 50. This is only for illustrative purposes. In practice each path may go through any number of currency conversions before returning to the base currency 50.

As indicated at 2210, a “currency path” or series of exchanges beginning with one currency and moving from that currency to another and repeating the process an desired number of times is represented. The lifetime of a currency path 2210 may be determined by a strategic mechanism or it may be determined by the user 54. The currency exchanges may strategically follow a path of greater gain until such time that the path 2210 may be terminated and the final currency in the path may be exchanged back to the base currency 50. This is relies upon the reality that all currencies have different exchange rates against each other in addition to each having their own exchange rate against the base currency 50. Over time there may be fluctuations of these exchange rates which may create opportunities for gain.

Two metrics that may be used for these evaluations are the “Gain Threshold,” as implemented by the currency gain module 20, and the “Pullback Score” as implemented by the currency pullback module 22. The following is a process that may utilize both of these criteria.

First, each of the starting currencies 52 may be evaluated against all other currencies 52. The current and previous rates for each currency 52 going back a predetermined amount of time may be compiled and compared. The gain percentage between the oldest rate and the current rate may be determined using the following formula: 1−(currentRate/originalRate). Each currency 52 may then be evaluated (e.g., in currency gain module 20) to determine if it has reached a predetermined gain threshold in any of the currencies 52 it is compared to. Next the pullback score of each currency 52 may be calculated (e.g., in currency pullback module 22). This may be done by compiling a list of plot points, where y is the current rate and x is the timestamp. The list of plot points may include the current rate and the previous rates going back a predetermined amount of time. In order to complete this evaluation the current trend may be calculated. Once the plot points have been aggregated they may be compared to each other to determine distance between each point. For example, if the current rate is 10 and the previous rate were 9 the distance would be 1. If the current rate is 9 and the previous rate was 10 the distance is −1. The direction of the data may be determined by calculating the mean between the plot points and determining if the mean is greater than zero (indicating an upward trend), less than zero (indicating a downward trend) or equal to zero (indicating no movement). A median of the rates may also be calculated and compared to the mean to determine if the trend is steep or gentle. Once the trend is determined a significant point may be identified. In an upward trend the highest rate would be considered the significant point, and in a downward trend the lowest point would be selected. Any points that fall after the significant point comprise the pullback line. If a pullback line is found the points may be used to calculate the slope of their linear regression, referred to as a pullback score. Any currency 52 that has met a gain percentage threshold and a pullback score threshold may then be compared to each other. The currency 52 with the highest gain may be selected.

Next, currencies 52 that meet this threshold may then be evaluated. The pullback score may be calculated using the formula previously mentioned. This score may then be used to see which currencies 52 meet the predetermined pullback score threshold.

Currencies 52 that meet this threshold may then be evaluated to determine which currencies 52 have higher gain and better pullback scores. The currencies 52 with higher scores may then be traded. If none of the currencies 52 that had a gain meet the pullback score threshold a “time limit” threshold may be set. Likewise, if none of the selected currencies 52 reach the pullback score threshold within the time limit the trade may be executed to the currency 52 that has a higher gain. After the trades are made the entire process may start again.

Continuing in the example of FIG. 7, at 2211, a first exchange made in this currency path may be from Gold Dollars to Ethereum. At 2212, a second exchange made in this currency path may be from Ethereum to Canadian Dollars. At 2213, a third exchange made in this currency path may be from Canadian Dollars to British pounds. And at 2214 a fourth and final exchange made in this currency path may be from British pounds to USD.

As shown at 2220 the logic that determines the path from one currency to the next is illustrated for the first exchange from Gold Dollars to Ethereum. As indicated at 2221, currencies 52 may be compared to the selected currency, in this case gold (e.g., FIG. 5A, at 64), and the currencies that Gold Dollars have realized a gain against (are weaker to Gold Dollars) may be sorted to the top (e.g., by currency sort module 26). In this example the Gold Dollar is representing a gain of 5% against Ethereum, 4% against Euros, and 4% against Silver Dollars. Other currencies 52 such as British pounds and Euros are representing that Gold Dollars would incur a loss if traded to them. So though they are represented as not having a gain they have actually increased in value against the Gold Dollar.

At 2222. currencies that report a gain may then be assessed for a pullback score. If the pull back score is within a proper threshold, a trade hop may be made to that currency 52. Alternatively if none of the currencies 52 that meet the gain threshold meet the pullback threshold a time limit may be assessed to give potential trades an opportunity to hit the score. If none of the potential trades reach the pullback score threshold in the time window the trade may be made anyway and the gain realized.

At 2223, current trades that have reached the gain threshold and the pullback score threshold are represented. If more than one currency 52 makes it to the final selection, a trade may be made for both to increase entropy and the currency path may then be “forked” into two currency paths.

At 2224 decision logic of when the time limit is reached is represented. In this scenario, Ethereum hit the pullback score and was exchanged. The Euro did not hit the pullback score and has entered into another time loop. The Silver Dollar also hit the pullback score and was sent on to be traded and create a different currency path. Note that if the Euro still has not reached the pullback score threshold against any other currency, the gain in relation to USD may be taken and traded back to USD. At 2225, a separate currency path is initiated when silver was traded is represented.

Although various embodiments have been shown and described, the present disclosure is not so limited and will be understood to include all such modifications and variations are would be apparent to one skilled in the art.

What is claimed is:

1. An apparatus comprising:
a currency gain module that compares a predominant base currency against one or more complementary currencies to calculate their respective percentage gains in the base currency over time;
a currency pullback module that calculates a pullback score for each complementary currency over time; and
a currency path module that determines one or more currency paths comprising one or more successive trades in which a complementary currency exceeding a gain threshold and satisfying a pullback threshold is traded,
wherein the currency gain module, the currency pullback module, and the currency path module comprise one or more of logic hardware and executable code, the executable code stored on one or more non- transitory computer-readable media.

2. The apparatus of claim 1, further comprising a currency sort module that monotonically orders the complementary currencies by their respective percentage gains.

3. The apparatus of claim 2, further comprising a currency hop module that calculates percentage gains between complementary currencies and identifies any currency paths that would achieve a higher overall percentage gain relative to the base currency than by trading each complementary currency alone.

4. The apparatus of claim 3, further comprising a currency select module that determines respective amounts of base currency yielded by trading predetermined amounts of the complementary currencies in descending order of percentage gain so as to achieve a total predetermined amount of base currency.

5. The apparatus of claim 4, wherein the trading determined by the currency select module comprises at least one currency path.

6. The apparatus of claim 5, wherein the at least one currency path comprises at least two successive trades.

7. The apparatus of claim 6, further comprising a paper legal tender trust account module, an exchange rate module, an arbitrage hedge account module, a bullion exchange module, a specie legal tender holdings module, and a specie legal tender disbursement module.

8. The apparatus of claim 6, further comprising a specie legal tender transaction entry module, a specie legal tender transaction verification module, a tax accounting module, a form of tender determination module, and a specie legal tender transaction execution module.

9. The apparatus of claim 6, further comprising a transactor verification module, an account verification module, an available balance verification module, and an account reconciliation module.

10. The apparatus of claim 6, wherein one or more of the modules use of one or more of a debit card, credit card, internet, telecommunications, wire transfer, and Automated Clearing House (“ACH”) system, by which information needed to execute a transaction is communicated to the apparatus and status of the transaction is communicated to transacting parties.

11. A system comprising:
a currency gain module that compares a predominant base currency against one or more complementary currencies to calculate their respective percentage gains in the base currency over time;
a currency pullback module that calculates a pullback score for each complementary currency over time;
a currency path module that determines one or more currency paths comprising one or more successive trades in which a complementary currency exceeding a gain threshold and satisfying a pullback threshold is traded;
a currency sort module that monotonically orders the complementary currencies by their respective percentage gains;
a currency hop module that calculates percentage gains between complementary currencies and identifies any currency paths that would achieve a higher overall percentage gain relative to the base currency than by trading each complementary currency alone;
a currency select module that determines respective amounts of base currency yielded by trading predetermined amounts of the complementary currencies in descending order of percentage gain so as to achieve a total predetermined amount of base currency; and
a computer in which the foregoing modules reside.

12. The system of claim 11, further comprising an authorization module that validates a user's identity and account holdings of base currency and complementary currency.

13. The system of claim 11, further comprising an exchange module that executes trades as determined by the currency path module and the currency select module.

14. A computer program product comprising a non-transitory computer readable medium having computer usable program code executable to perform operations for intelligent choice in currency, the operations of the computer program product comprising:
comparing a predominant base currency against one or more complementary currencies to calculate their respective percentage gains in the base currency over time;
calculating a pullback score for each complementary currency over time; and
determining one or more currency paths comprising one or more successive trades in which a complementary currency exceeding a gain threshold and satisfying a pullback threshold is traded;
monotonically ordering the complementary currencies by their respective percentage gains;
calculating percentage gains between complementary currencies and identifying any currency paths that would achieve a higher overall percentage gain relative to the base currency than by trading each complementary currency alone;
determining respective amounts of base currency yielded by trading predetermined amounts of the complementary currencies in descending order of percentage gain so as to achieve a total predetermined amount of base currency.

15. A machine-implemented method for intelligent choice in currency, the method comprising the steps of:
comparing a predominant base currency against one or more complementary currencies to calculate their respective percentage gains in the base currency over time;
calculating a pullback score for each complementary currency over time; and
determining one or more currency paths comprising one or more successive trades in which a complementary currency exceeding a gain threshold and satisfying a pullback threshold is traded;
monotonically ordering the complementary currencies by their respective percentage gains;
calculating percentage gains between complementary currencies and identifying any currency paths that would achieve a higher overall percentage gain relative to the base currency than by trading each complementary currency alone;
determining respective amounts of base currency yielded by trading predetermined amounts of the complementary currencies in descending order of percentage gain so as to achieve a total predetermined amount of base currency.
